(19) United States
(12) Patent Application Publication
(10) Pub. No.: US 2013/0063771 A1
(43) Pub. Date: Mar. 14, 2013

(54) APPARATUS AND METHOD FOR UPLOADING IMAGE FILE OF APPARATUS TO SOCIAL NETWORK SERVICE

(71) Applicants: Mi-sook SONG, Suwon-si (KR); Hyung-jong Kang, Seoul (KR); Hee-chul Jung, Suwon-si (KR); In-chang Park, Seoul (KR)

(72) Inventors: Mi-sook SONG, Suwon-si (KR); Hyung-jong Kang, Seoul (KR); Hee-chul Jung, Suwon-si (KR); In-chang Park, Seoul (KR)

(73) Assignee: SAMSUNG ELECTRONICS CO., LTD., Suwon-si (KR)

(21) Appl. No.: 13/473,015

(22) Filed: May 16, 2012

(30) Foreign Application Priority Data
Sep. 9, 2011 (KR) 2011-0092255

(51) Int. Cl. G06F 3/12

(52) U.S. Cl. 358/1.15

(57) ABSTRACT

An apparatus and a method for uploading an image file of the apparatus to a social network service (SNS) site are provided. The method includes displaying history information on a user interface (UI) screen, which is displayed on a display unit of the apparatus, through an application executed in the apparatus, selecting an image file displayed in the history information, selecting an SNS site, and uploading the selected image file to the selected SNS site. The history information is generated by the application so as to correspond to an image file. The image file may be generated through the image scanning apparatus and uploaded to the SNS site, generated through the image scanning apparatus and not uploaded to the SNS site, or stored in a storage unit of the apparatus and uploaded to the SNS site.

### CROSS-REFERENCE TO RELATED APPLICATIONS

This application is related to and claims priority from Korean Patent Application No. 2011-0092255, filed on Sep. 9, 2011, in the Korean Intellectual Property Office, the disclosure of which is incorporated herein by reference.

### BACKGROUND

1. Field

The exemplary embodiments discussed herein relate to an apparatus and a method for uploading an image file of the apparatus to a social network service (SNS) site, and more particularly, to an apparatus which uploads an image file, which is scanned and transmitted from a connectable image scanning apparatus, to an SNS site selectable by a scan application, and a method for uploading the image file of the apparatus to the SNS site.

2. Description of the Related Art

Examples of an image scanning apparatus may include a scanner, a fax machine, a multifunction peripheral (MFP), etc. which scan an image to generate an image file. The MFP may perform a plurality of functions including copying, printing, scanning, and faxing.

A device driver or an application may be installed in a computer which is connected to an image scanning apparatus through a wire/wireless network or a universal serial bus (USB) interface in order to control the image scanning apparatus or perform at least one function supported by the image scanning apparatus.

The application is software necessary to use the image scanning apparatus or an apparatus connectable to the image scanning apparatus and varies according to manufacturing companies.

An application may be installed in the computer, which is connected to the image scanning apparatus, so that the image scanning apparatus scans a photo or a document and transmits an image file corresponding to the scanned photograph or document to the computer. The image file received from the image scanning apparatus is stored in the computer. A web browser installed in the computer is executed to log in a social network service (SNS) site, in which a human network may be formed on a web, and upload the image file stored in the computer to the SNS site.

### SUMMARY

Additional aspects and/or advantages will be set forth in part in the description which follows and, in part, will be apparent from the description, or may be learned by practice of the invention.

One or more exemplary embodiments may overcome the above disadvantages and other disadvantages not described above.

One or more exemplary embodiments provide an apparatus and a method for uploading an image file of the apparatus to a social network service (SNS) site.

According to an aspect of an exemplary embodiment, a method is provided for uploading an image file of an apparatus, which is connectable to an image scanning apparatus, to a social network service (SNS) site. The method may include, displaying history information on a user interface (UI) screen, which is displayed on a display unit of the apparatus, through an application executed in the apparatus; selecting an image file displayed in the history information; selecting an SNS site, and uploading the selected image file to the selected SNS site, wherein the image file is scanned and generated by the image scanning apparatus through the application.

The method may include performing a configuration for logging in the SNS site.

The method may include logging in the SNS site by using the configuration, and displaying the SNS site, to which the selected image file has been uploaded, on a web browser screen executed in the apparatus.

The method may including providing an option for storing the scanned image file in a storage unit of the apparatus or uploading the scanning image file to the SNS site.

The SNS site may be selected to be distinguishably displayed according to whether it is possible to upload the selected image file.

If a plurality of SNS sites are selected, the selected image file may be uploaded sequentially to the plurality of SNS sites.

The method may include generating history information corresponding to the image and storing the history information in the storage unit of the apparatus.

The history information may be generated by the application so as to correspond to one of first, second, and third image files, wherein the first image file may be generated through the image scanning apparatus and uploaded to the SNS site, the second image file may be generated through the image scanning apparatus and is not uploaded to the SNS site, and the third image file may be pre-stored in a storage unit of the apparatus and uploaded to the SNS site.

The selected image file may be uploaded by using an application programming interface (API) corresponding to the selected SNS site.

The selected image may be scheduled to be uploaded to the SNS site.

The uploading of the selected image file may comprise setting a period for which the selected image file is posted in the SNS site; and if the period is expired, deleting the image file uploaded to the SNS site.

According to an aspect of an exemplary embodiment, an apparatus is provided which is connectable to an image scanning apparatus. The apparatus may include a communication interface unit which is connectable to the image scanning apparatus; a controller which controls the communication interface unit, and a storage unit, wherein the controller controls an application to select an image file and an SNS site from a UI screen provided by the application displayed on a display unit of the apparatus and upload the selected image file to the selected SNS site. The image file may be scanned and generated by the image scanning apparatus or may be pre-stored in the storage unit of the apparatus to be selected.

The controller may request the image scanning apparatus through the communication interface unit to generate the image file.

The controller may control a transmitting the selected image file to the SNS site through the communication interface unit.

The controller may control a performing a configuration for logging in the SNS site and display the SNS site, to which the image file has been uploaded, on a web browser screen displayed on the display unit of the apparatus through logging in the SNS site by using the configuration.

The apparatus and the display unit may be all-in-one.

According to an aspect of an exemplary embodiment, a method id provided of uploading an image file of an apparatus, which is connectable to an image scanning apparatus, to an SNS site. The method may include, requesting the image scanning apparatus through an application executed in the apparatus to generate the image file in a scan unit of the image scanning apparatus, receiving the image file from the image scanning apparatus, selecting an SNS site to which the received image file is to be uploaded, and uploading the received image file to the selected SNS site.

The method may include logging in the SNS site, wherein the SNS site to which the image file has been uploaded is displayed on the web browser screen executed in the apparatus through logging in the SNS site.

If a plurality of SNS sites are selected, the selected image file may be uploaded sequentially to the plurality of SNS sites.

According to an aspect of an exemplary embodiment, a method is provided of uploading an image file of an apparatus, which is connectable to an image scanning apparatus, to an SNS site. The method may include displaying history information on a UI screen displayed on a display unit of the apparatus through an application executed in the apparatus, selecting an image file displayed in the history information, selecting an SNS site, and uploading the selected image file to the selected SNS site. The history information may be generated by the application so as to be one of first, second, and third image files, wherein the first image file may be generated by the image scanning apparatus and uploaded to an SNS site, the second image file may be generated by the image scanning apparatus and is not uploaded to the SNS site, and the third image file may be pre-stored in a storage unit of the apparatus and uploaded to the SNS site.

The method may further include logging in the SNS site; and displaying the SNS site, to which the selected image file has been uploaded, on a web browser screen executed in the apparatus.

The history information may be provided as one of an image type and a list type through the application executed in the apparatus, wherein the image type is to display a thumbnail image corresponding to an image file on the UI screen displayed on the display unit of the apparatus by the application, and the list type is to display the thumbnail image as texts corresponding to the image file.

The SNS site may be selected to be distinguishably displayed according to whether it is possible to upload the selected image file.

The selected image file may be uploaded to the selected SNS site by using an application programming interface (API) corresponding to the selected SNS site.

The selected image file may be scheduled to be uploaded to the SNS site.

The uploading of the selected image file may include setting a period for which the selected image file is posted in the SNS site.

According to an aspect of an exemplary embodiment, an apparatus is provided which is connectable to an image scanning apparatus. The apparatus may include a communication interface unit which is connectable to the image scanning apparatus; a controller which controls the communication interface unit, and a storage unit, wherein the controller controls an application to display history information on a UI screen provided by the application displayed on a display unit of the apparatus, select an image file from the displayed history information, and select an SNS site to upload the selected image file to the selected SNS site, wherein the history information is generated by the application.

The history information may be generated by the application so as to correspond to one of first, second, and third image files, wherein the first image file is generated through the image scanning apparatus and uploaded to the SNS site, the second image file is generated through the image scanning apparatus and is not uploaded to the SNS site, and the third image file is pre-stored in the storage unit of the apparatus and uploaded to the SNS site.

The controller controls the communication interface unit for transmitting the selected image file to the SNS site by using an API corresponding to the SNS site.

The controller may control a login to the SNS site and display the SNS site, to which the image file has been uploaded, on a screen of a web browser displayed on the display unit through the logging in.

The apparatus and the display unit may be all-in-one.

According to an aspect of an exemplary embodiment, a method is provided of uploading an image file of an apparatus, which is connectable to an image scanning apparatus, to an SNS site. The method may include selecting an image file, which is to be uploaded to an SNS site, on a UI screen displayed on a display unit of the apparatus through an application executed in the apparatus; selecting an SNS site; and uploading the selected image file to the selected SNS site, wherein the image file is pre-stored in a storage unit of the apparatus to be selected by the application.

According to an aspect of an exemplary embodiment, an apparatus and a method are provided for uploading an image file, which is scanned and generated by an image scanning apparatus, to a selected SNS site.

According to an aspect of an exemplary embodiment, an apparatus and a method are provided for selecting an image file, which is stored in a storage unit of the apparatus, and uploading the selected image file to a selected SNS.

According to an aspect of an exemplary embodiment, an apparatus is provided which stores history information corresponding to an image file generated by an image scanning apparatus and history information corresponding to an image file which is pre-store din the apparatus and loaded from the apparatus, and a method of uploading the image file of the apparatus to an SNS site.

According to an aspect of an exemplary embodiment, an apparatus and a method are provided for scheduling a selected image file to upload the selected image file to a selected SNS site.

According to an aspect of an exemplary embodiment, an apparatus and a method are provided for loading stored history information through a scan application to upload an image file selected in the history information to a selected SNS site.

According to an aspect of an exemplary embodiment, there are provided an apparatus and a method for generating an image file through an image scanning apparatus by using one application and uploading the generated image file to a selected SNS site.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and/or other aspects will be more apparent by describing in detail exemplary embodiments, with reference to the accompanying drawings, in which:

FIG. 1 is a schematic block diagram illustrating an apparatus according to an exemplary embodiment;

FIG. 2 is a flowchart schematically illustrating a method of uploading an image file of an apparatus to a social network service (SNS) site according to an exemplary embodiment;

FIGS. 3 through 13 are views illustrating a method of uploading an image file of an apparatus to an SNS site according to an exemplary embodiment;

FIG. 14 is a view illustrating an SNS site login setup of an apparatus according to an exemplary embodiment;

FIG. 15 is a flowchart schematically illustrating a method of uploading an image file of an apparatus to an SNS site according to another exemplary embodiment; and

FIGS. 16 through 22 are views illustrating a method of uploading an image file of an apparatus to an SNS site according to another exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

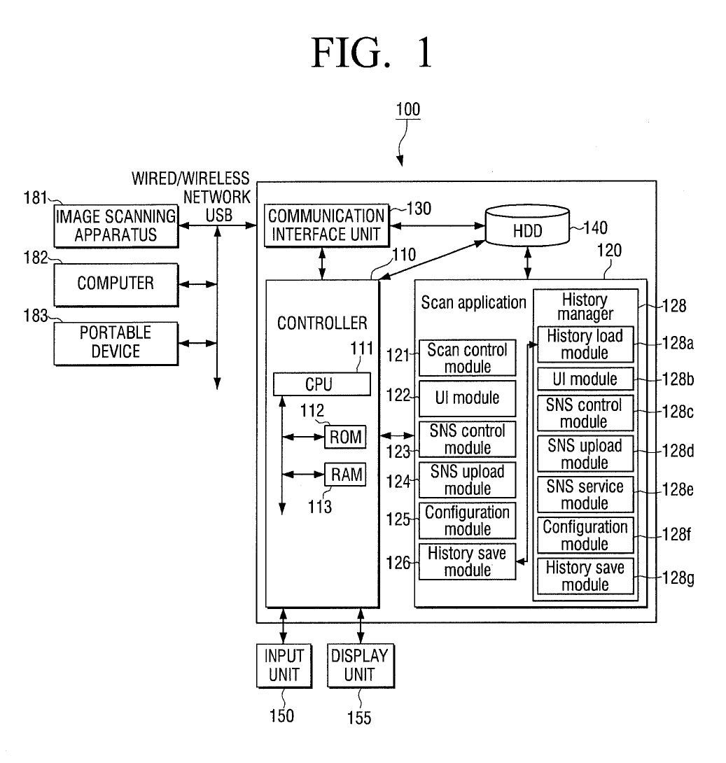

FIG. 1 is a block diagram schematically illustrating an apparatus 100 according to an exemplary embodiment.

Referring to FIG. 1, the apparatus 100 may access a wired or wireless network. The apparatus 100 may access a universal serial bus (USB) interface (not shown).

The apparatus 100 may be connected to an image scanning apparatus 181, a computer 182, and a portable device 183 by using the wired/wireless network and the USB interface.

The image scanning apparatus 181 scans an image (e.g., including a photo or a film) by using a scan unit to generate image data. Examples of the image scanning apparatus 181 may include a scanner, a fax machine, and a multifunction peripheral (MFP). The computer 182 may be a personal computer (PC) or a server having a social network service (SNS) site which will be described in the present inventive concept. The portable device 183 may be a mobile phone, a smart phone, a digital camera, an e-book reader, a tablet PC, a portable storage medium (e.g., a USB memory, a memory card, or the like) but is not limited thereto. An “external device” may refer to the image scanning apparatus 181, the computer 182, and/or the portable device 183.

According to an exemplary embodiment, a mobile phone, a smart phone, a digital camera, or a tablet PC having a camera unit (not shown) capable of capturing a still image or a video may be included in an example of the image scanning apparatus 181. Scanning may include capturing or photographing of an image. Image data having a file extension, e.g., jpg, tiff, or the like, may be defined as an image file. The image data generated by the image scanning apparatus 181 may be transmitted to the apparatus 100 and then stored as an image file in a storage unit (not shown) of the apparatus 100. Alternatively, the image data may be stored as an image file in a storage unit (not shown) of the image scanning apparatus 181 and then transmitted to the apparatus 100. The term “image file” includes image data.

The apparatus 100 includes a controller 110, a scan application 120, a communication interface unit 130, and a hard disk drive (HDD) 140. The scan application 120 includes a scan control module 121, a user interface (UI) module 122, an SNS control module 123, an SNS upload module 124, a configuration module 125, and a history save module 126. The scan application module 120 includes a history manager 128 which includes a history load module 128a, a UI module 128b, an SNS control module 128c, an SNS upload module 128d, an SNS service module 128e, a configuration module 128f, and a history save module 128g. An input unit 150 or a display unit 155 may be connected to the apparatus 100.

The controller 110 includes a central processing unit (CPU) 111, a read-only memory (ROM 112), and a random access memory 113. The ROM 112 stores a control program for controlling the apparatus 100, and the RAM 113 stores a signal or data input outside the apparatus 100 or is used as a memory space for a job performed by the apparatus 100. The CPU 111 may include a single core, a dual core, a triple core, or a quad core according to the number of CPU cores. The CPU 111, the ROM 112, and the RAM 113 may be connected to one another through an internal bus. The term “storage unit” may refer to the ROM 112 or the RAM 130 of the controller 110, the HDD 140, or a memory card (e.g., a secure digital (SD) card, a memory stick, or the like) installed in the apparatus 100. Examples of the storage unit may include a nonvolatile memory, a volatile memory, a HDD, and a solid state drive (SSD).

The controller 110 controls the scan application 120, the communication interface unit 130, the HDD 140, the input unit 150, and the display unit 150. The controller 110 may control an external device through the communication interface unit 130. For example, the controller 110 loads an image file scanned by the image scanning apparatus 181 or an image file stored in an storage of the external device and displays the loaded image file on the display unit 155 or may store an image file stored in the storage unit of the apparatus 100 in the storage unit of the external device.

The scan application 120 includes the scan control module 121, the UI module 122, the SNS control module 123, the SNS upload module 124, the configuration module 125, and the history save module 126.

The scan control module 121 searches for the image scanning apparatus 181, which is connectable to the apparatus 100, by using the controller 110 and the communication interface unit 130 and controls the searched image scanning apparatus 181. The scan control module 121 requests the image scanning apparatus 181 to scan (e.g., pre-scan or scan) an image put on the scan unit of the image scanning apparatus 181 and to generate image data. The scan control module 121 transmits the image data generated by the image scanning apparatus 181 to the communication interface unit 130 of the apparatus 100. The image data received through the communication interface unit 130 of the apparatus 100 may be stored as an image file in the storage unit of the apparatus 100. The scan control module 121 stores the image data, which is generated by the image scanning apparatus 181, as an image file and transmits the image file to the apparatus 100.

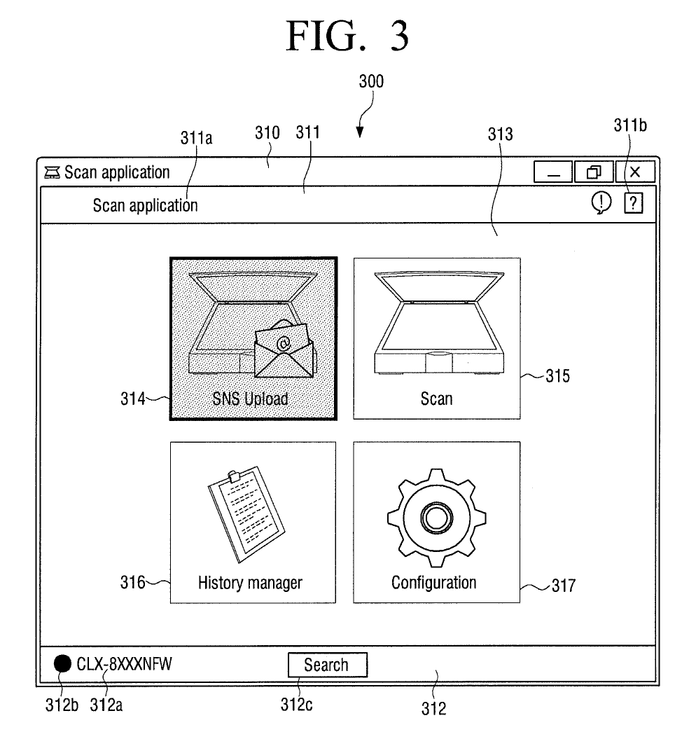

The UI module 122 provides an UI of the scan application 120 displayed on the display unit 155. The UI refers to an interface which includes a graphic (including an icon or texts), a gesture, a voice, etc. which are provided to smooth an interaction between a user and the apparatus 100 and easily use the apparatus 100. On a UI screen provided by the UI module 122, image scanning apparatuses are searched for, and a list of searched image scanning apparatuses is displayed. An image file, which is to be uploaded to an SNS site, is displayed and selected by the user. The SNS site to which the image file is to be uploaded is displayed and selected by the user. An upload result of the image file uploaded to the SNS site may be displayed. FIGS. 3 through 7 and FIGS. 10 through 14 illustrate UI screens provided by the scan application 120, according to exemplary embodiments.

The SNS control module 123 searches for an SNS site, which is connectable to the apparatus 100, by using the controller 110 and the communication interface unit 130, and logs in the searched SNS site. If a selected image file is completely uploaded to the logged-in SNS site through an identification (ID) and a password of the user, the SNS control module 128c displays the SNS site, in which the image file has been uploaded through a web browser, on the display unit 155.

The SNS upload module 124 may upload at least one selected image file (e.g., one image file or a plurality of image files) to at least one selected SNS site (e.g., one SNS site or a plurality of SNS sites). The SNS upload module 124 may upload at least one image file by using an application programming interface (API) corresponding to the selected SNS site. The selected image file may be an image file which is scanned by the image scanning apparatus 181 and then stored in the apparatus 100 or an image file which is pre-stored in the storage unit of the apparatus 100.

If an SNS site supports only texts, an image file may be uploaded to an additional site not to the selected SNS site. Link information (e.g., a uniform resource locator (URL)) of an image file stored in the additional site may be displayed on an SNS site displayed in a web browser which is executed. If the displayed link information of the image file is selected, the image file stored in the additional site may be displayed in the web browser. If an SNS site supports an image, the SNS site to which an image file is uploaded may be displayed in the web browser. The SNS control module 123 and the SNS upload module 124 may be realized as one SNS module (not shown).

The configuration module 125 sets a configuration corresponding to the scan application 120. The configuration module 125 may set an SNS login (e.g., set an ID and a password corresponding to an SNS site) to log in an SNS site. For example, one SNS site may be selected, and then an ID and a password may be input, or a plurality of SNS sites may be selected, and then the same ID and password may be set. The SNS control module 123 may log in a corresponding SNS site by using the set ID and password. If an ID and a password corresponding to a selected SNS site are not set by the configuration module 125, the ID and the password corresponding to the SNS site are to be manually input to upload an image file to the SNS site.

The configuration module 125 may set scan options corresponding to a scan (including a pre-scan). The configuration module 125 may set an image type (e.g., a color, a gray, etc.) of the image file generated by the image scanning apparatus 181, a document size (e.g., a photo of A5, A4, or “4×6” size), a resolution (e.g., 300 dpi), and a file type (e.g., file extension “bmp,” “jpg,” “pdf,” “tif,” or the like).

The history save module 126 stores history information of an image file generated by the image scanning apparatus 181, history information of an image file pre-stored in the storage unit and uploaded to an SNS site, or history information of an image file (e.g., which is not uploaded to the SNS site) generated by the image scanning apparatus 181 and stored in the storage unit of the apparatus 100.

The stored history information includes the plural number among a save date, a save position (e.g., c:\temp\), a file name, a file format, a size of an image file (e.g., 240 KB), a schedule setup, a post period, and a name of an uploaded SNS site (e.g., Twitter®, Facebook®, or the like). The history save module 126 may store an ID and path information (e.g., http://twitpic.com/5vnxy5) of an image file, which is uploaded to the SNS site, in the history information. The history manager 128 may delete the image file, which has been uploaded to the SNS site, by using the SNS login setup set by the configuration module 125 and the path information of the history information stored by the history save module 126.

The history save module 126 may store the history information in the storage unit of the apparatus 100 or in the storage unit of the external device through the communication interface unit 130. The history save module 126 may store the history information in a markup language including an eXtended Markup Language (XML) or may store the history information as a text file having a file extension such as “txt,” “rtf,” or the like. The history save module 126 may periodically (e.g., hourly or daily) update the history information. The stored history information may be loaded from the history load module 128a of the scan application 120. If the history information loaded from the history load module 128a is revised, the history information may be updated.

The history manager 128 includes the history load module 128a, the UI module 128b, the SNS control module 128c, the SNS upload module 128d, the SNS service module 128e, the configuration module 128f, and the history save module 128g.

The history manager 128 may load the history information from the history save module 126 to upload the image file, which is generated by the image scanning apparatus 181, is not uploaded to the SNS site, and is pre-stored in the storage unit, to the SNS site or to re-upload an image file, which is previously uploaded to the SNS site, to the SNS site (e.g., the same SNS site or another SNS site).

The history load module 128a may load the history information from the history save module 126 and display the history information on the display unit 155. If a history manager task 316 is executed on a home screen 300, the history information may be displayed by the history load module 128a.

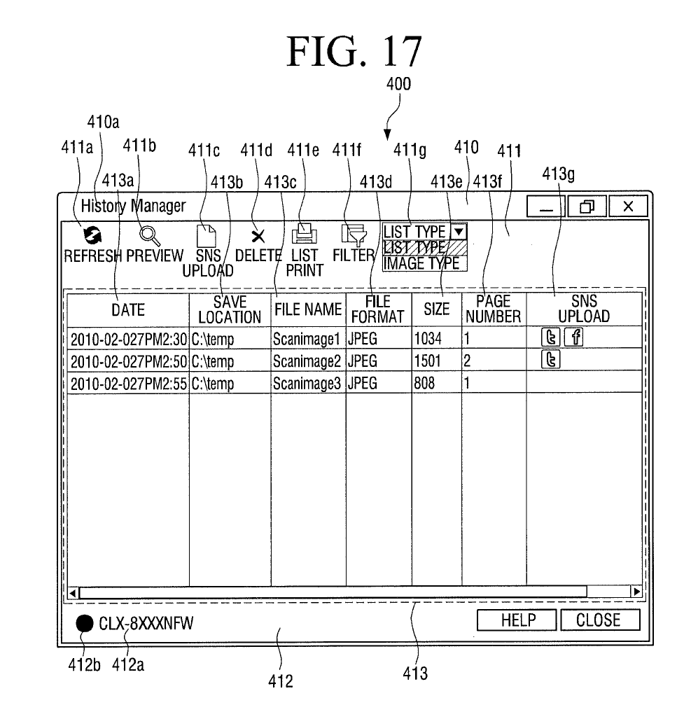

The UI module 128b provides the UI screen of the history manager 128 displayed on the display unit 155. The history information (e.g., the plural number among the save date, the save location, the file name, the file format, the file size, and the name of the uploaded SNS site) loaded from the history load module 128a is displayed on the UI screen provided by the UI module 128b. The image file uploaded to the SNS site is selected by the user. The SNS site to which the image file has been uploaded is displayed and selected by the user. An upload result of the image file uploaded to the selected SNS site may be displayed. FIGS. 17 through 19 and 21 illustrate examples of the UI screen provided by the scan application 120, according to exemplary embodiments.

The SNS control module 128c searches for an SNS site, which is connectable to the apparatus 100, by using the controller 110 and the communication interface unit 130 and logs in the searched SNS site. If the selected image file is completely uploaded to the logged-in SNS site through the ID and password of the user, the SNS control module 128c displays the SNS site, to which the image file is uploaded through a web browser, on the display unit 155. The SNS control module 128c of the history manager 128 is substantially similar to the SNS control module 123.

The SNS upload module 128d may upload at least one image file (e.g., one image file or a plurality of image files) selected from the displayed history information to at least one selected SNS site (e.g. one SNS site or a plurality of SNS sites). The SNS upload module 128d may re-upload at least one image file to an SNS site (e.g., a pre-uploaded SNS site) registered in the history information. The SNS upload module 128d of the history manager 128 is substantially similar to the SNS upload module 124, and thus repeated descriptions are omitted. The SNS control module 128c and the SNS upload module 128d of the history manager 128 may be realized as one SNS module (not shown).

The SNS service module 128e may upload at least one selected image file to a selected SNS site by using the SNS upload module 128d according to a date and a time of an input scheduled delivery. The SNS service module 128e may delete the image file uploaded to the SNS site by using a deletion API corresponding to the stored history information and the selected SNS site. The SNS service module 128e may delete at least one image file, of which post period has elapsed, by using the deletion API corresponding to the stored history information and the selected SNS site. If the deletion API corresponding to the SNS site does not exist, the SNS service module 128e may not delete the image file uploaded to the SNS site.

The configuration module 128f sets a configuration of the history manager 128. The configuration module 128f may set a display type (e.g., one of a text type and an image type) of the displayed history information. The configuration module 128f of the history manager 128 is substantially similar to the configuration module 125, and thus repeated descriptions are omitted.

The history save module 128g may store history information of an image file of which history information has been changed in the history manager 128. The history save module 128g of the history manager 128 is substantially similar to the history save module 126, and thus repeated descriptions are omitted.

The SNS control module 123 of the scan application 120 and the SNS control module 128c of the history manager 128 may be realized as one common module (not shown). The SNS upload module 124 of the scan application 120 and the SNS upload module 128d of the history manager 128 may be realized as one common module (not shown). In addition, the history save module 126 of the scan application 120 and the history save module 128g of the history manager 128 may be realized as one command module (not shown). The common modules may be used by the scan application 120 and the history manager 128.

The communication interface unit 130 may be connected to the external device through the wired/wireless network or the USB interface. The apparatus 100 requests the image scanning apparatus 181 through the communication interface unit 130 to scan an image and generate an image file corresponding to the scanned image under control of the controller 110 or the scan application 120. Under control of the controller 110 or the scan application 120, the image scanning apparatus 181 transmits the generated image file to the communication interface unit 130. The apparatus 100 may request the image file stored in the storage unit of the external device through the communication interface unit 130 under control of the controller 110 or the scan application 120. The image scanning apparatus 181 may transmit the stored image file to the communication interface unit 130. The image scanning apparatus 181 may store the generated history information in the storage unit of the external device through the communication interface unit 130 under control of the controller 110 or the scan application 120. The history information stored in the storage unit of the external device may be loaded to the apparatus 100 under control of the controller 110 or the scan application 120.

The scan application 120 may be installed in the HDD 140. The history manager 128 may be installed in the HDD 140. The image file transmitted from the image scanning apparatus 181 or a pre-generated image file is stored in the HDD 140 under control of the controller 110 or the scan application 120. History information generated by the scan application 120 and the history manager 128 is stored in the HDD 140. An API for uploading an image file to an SNS site is stored in the HDD 140.

An input of the user to control the apparatus 100 is input through the input unit 150 connected to the apparatus 100. The input unit 150 may be a keyboard, a mouse, a touch screen, or various types of hardware or software modules.

The display unit 155 is connectable to the apparatus 100 and displays shortcut icons (not shown) corresponding to applications supported by the apparatus 100. A UI screen corresponding to the scan application 120 or the history manager 128 may be displayed on the display unit 155 according to the present exemplary embodiment.

The display unit 155 may be a cathode-ray tube (CRT) monitor (not shown), a thin film transistor-liquid crystal display (TFT-LCD) monitor (not shown), and/or a touch screen which displays the above-described contents and performs a display and an input of a user. If the display unit 155 is a touch screen, the apparatus 100 may be an all-in-one type and the input unit 150 and the display unit 155 not separated from each other. The display unit 155 may be an all-in-one type so as not to be separate from the apparatus 100.

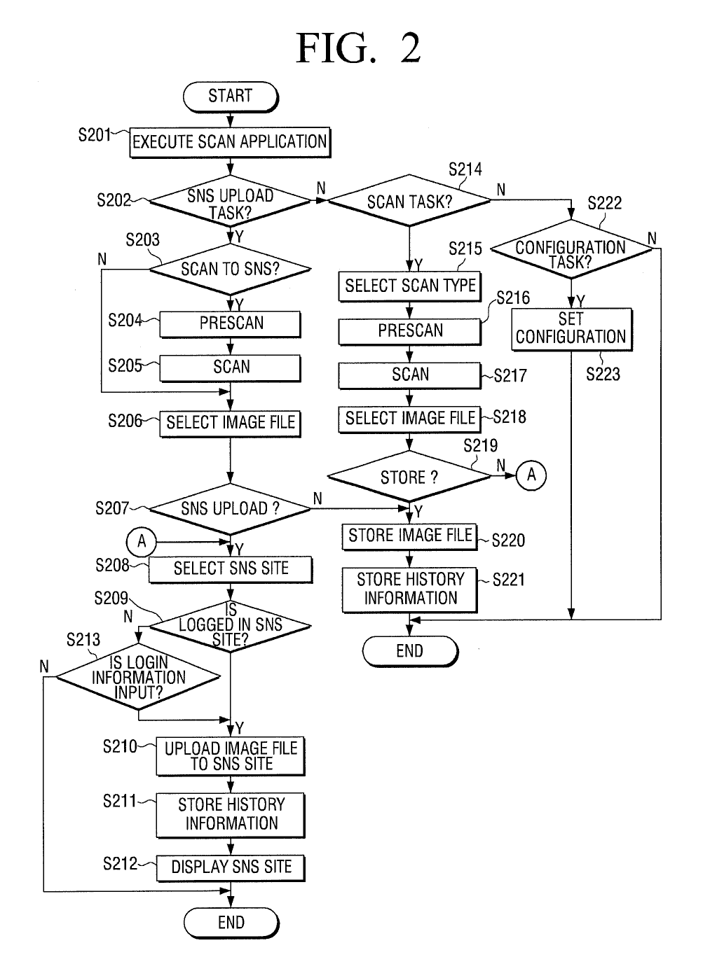

FIG. 2 is a flowchart schematically illustrating a method of uploading an image file of an apparatus to an SNS site according to an exemplary embodiment.

Referring to FIG. 2, in operation S201, a scan application is executed.

FIGS. 3 through 13 are views illustrating a method of uploading an image file of an apparatus to an SNS site according to an exemplary embodiment.

If a shortcut icon (not shown) corresponding to the scan application 120 displayed on a wallpaper of the display unit 155 is selected by a user or a shortcut icon (not shown) corresponding to the scan application 120 displayed on a task bar is selected, the scan application 120 may be executed. If the scan application 120 is executed, a first screen (hereinafter referred to as a home screen) 300 provided by the scan application may be displayed on the display unit 155. According to an exemplary embodiment, an ID and a password of the user input in consideration of security correspond to an ID and a password of the user that are pre-stored, the scan application may be executed.

In operation S202, an SNS upload task is selected.

Referring to FIG. 3, the home screen 300 includes a title area 310, a first information area 311, a second information area 312, and a task display area 313. The tile area 310 displays a name of a scan application, and the first information area 311 is positioned underneath the title area 310 and displays a program name 311a (e.g., a scan application). The second information area 312 may be positioned under the first information area 311 and includes a model name 312a of the image scanning apparatus 181 connected to the apparatus 100 and a connection state icon 312b of which color or shape is changed according to a connection state with the connected image scanning apparatus 181. The task display area 313 may be positioned between the first and second information areas 311 and 312 and displays tasks 314 through 317 provided from the scan application 120. The first information area 311 may include a help button 311b. The second information area 312 may include a search button 312c for searching for the image scanning apparatus 181 which is connectable. If a plurality of image scanning apparatuses are searched for, a list of image scanning apparatuses (not shown) corresponding to the searched image scanning apparatuses may be displayed, and an image scanning apparatus may be selected. In FIG. 3, an SNS upload task 314, a scan task 315, a history manager task 316, and a configuration task 317 are displayed. The tasks 314 through 317 displayed in the task display area 313 may be added or deleted according to a configuration set in the configuration task 317.

The SNS upload task 314 is selected in the task display area 313 of the home screen 300 through the input unit 150 or a touch (e.g., if the display unit 155 is a touch screen). The selected SNS upload task 314 may be displayed to be distinguished from the other tasks 315 through 317 of the task display area 313.

In operation S203, an SNS scan (Scan-to-SNS) is selected.

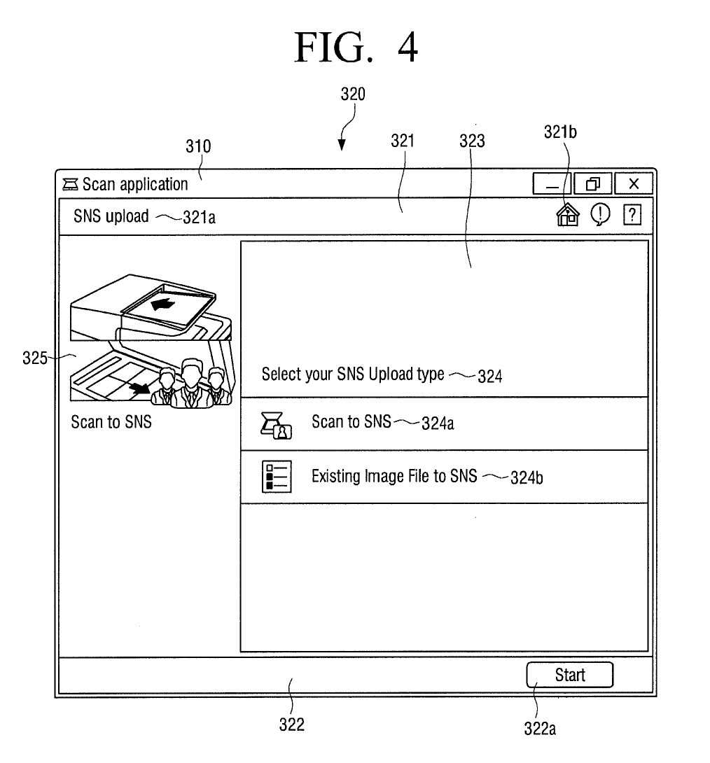

Referring to FIG. 4, an SNS upload task screen 320 includes a title area 310, a first information area 312, a second information area 322, and an SNS upload task type display area 323. The title area 310 displays a name of a scan application, and the first information area 321 may be positioned underneath the title area 310 and display a task name 321a (e.g. SNS upload) and a home button 321 for moving the SNS upload task screen 320 to the home screen 300. The second information area 322 is positioned under the first information area 321 and includes a start button 322a for selecting one of SNS upload types 324a and 324b and start a task. The SNS upload task type display area 323 is positioned between the first and second information areas 321 and 322 and displays an SNS upload type 324 provided from the SNS upload task 314. The SNS upload task type display area 323 displays a plurality of SNS upload types including “SNS scan” 324a and “Existing Image File to SNS” 324b. Task types 324a and 324b displayed in the SNS upload task type display area 323 may be added or deleted according to the configuration set in the configuration task 316.

The SNS scan 324a is selected in the SNS upload task type display area 323 of the SNS upload task screen 320 through the input unit 150 or a touch (e.g., if the display unit 150 is a touch screen). The selected SNS scan 324a may be displayed to be distinguished from the other task type 324b of the SNS upload task type display area 323. If a cursor is positioned in the SNS scan 324a, an icon 325 corresponding to the SNS scan 324a in which the cursor is positioned may be displayed on a side of the SNS upload task type display area 323.

If the start button 322a of the second information area 322 is selected, the SNS scan 324a starts. If the SNS scan 324a of the SNS upload task type display area 323 is selected, the SNS scan 324a may start without the start button 322a. If “Existing Image File to SNS” 324b stored in the SNS upload task type display area 323 of the SNS upload task screen 320 is selected, the method goes to operation S206.

In operation S204 of FIG. 2, pre-scanning is performed.

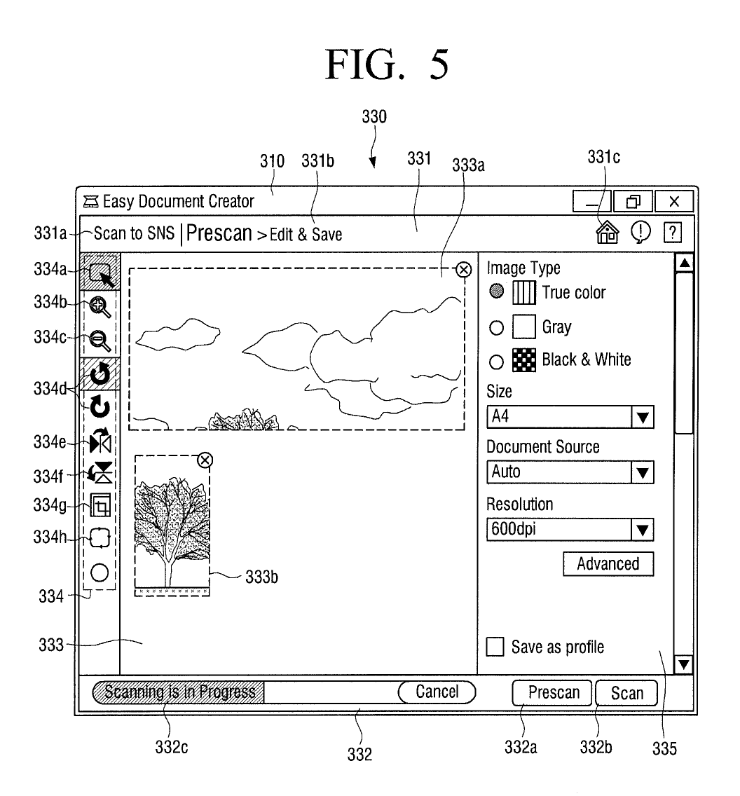

Referring to FIG. 5, a pre-scan screen 330 includes a title area 310, a first status area 331, a second status area 332, and a preview area 333. The title area 310 displays a name of a scan application, and the first status area 331 is positioned underneath the title area 310 and displays a task name 331a, a step indicator 331b, and a home button 331c for moving the pre-scan screen 300 to the home screen 300. The second status area 332 is positioned under the first status area 331 and includes a pre-scan button 332a for starting pre-scanning in the image scanning apparatus 181, a scan button 332b for starting scanning, and a progress bar 332c for displaying a progress status of pre-scanning. The preview area 333 is positioned underneath the first status area 331 and displays an image file which is pre-scanned by the image scanning apparatus 181.

The pre-scan screen 330 may include at least one of a toolbar area 334 and an option area 335. The toolbar area 334 is positioned on a side of the preview area 333 and displays an edit tool for editing a pre-scanned image file. The option area 335 is positioned on a side of the preview area 333 and sets pre-scan options or scan options with respect to an image file. The pre-scan screen 330 may include one or both of the toolbar area 334 and the option area 335.

Referring to FIG. 5, the step indicator 331b displays “Prescan>Edit & Save” indicating a pre-scanning process. If the image scanning apparatus 181 starts pre-scanning, “>” in the step indicator 331b blinks. If pre-scanning is ended, blinking of “>” in the step indicator 331b is ended. According to an exemplary embodiment, blinking may be one of various display effects, and the display effects may be changed.

If an option (e.g., an image type, an image size, or a resolution) for pre-scanning is set in the option area 335, and the pre-scan button 332a of the second status area 332 is selected, the scan application 120 or the controller 110 requests the image scanning apparatus 181 through the communication interface unit 130 to pre-scan an image put on a flatbed (not shown) or an auto document feeder (ADF) (not shown) of the image scanning apparatus 181 according to the option set in the option area 335. The image scanning apparatus 181 may pre-scan the image according to the set option and transmit a generated image file to the communication interface unit 130.

The image file received from the image scanning apparatus 181 may be temporarily stored in the storage unit of the apparatus 100. The image file which is temporarily stored in the storage unit of the apparatus 100 is displayed in the preview area 333. A pre-scan progress status of an image file 333a displayed in the preview area 333 may be displayed through the progress bar 332c of the second status area 332. The pre-scan progress status may include a pre-scanning process of the image scanning apparatus 181, a process of transmitting a generated image file to the apparatus 100, and a process of processing an image of the received image file in the apparatus 100. The pre-scanning process, the transmitting process, and the image processing process may be displayed to be distinguished from one another.

The image file 333a may be displayed in the preview area 333 so as to correspond to a progress degree of the progress bar 332c. For example, if the progress degree of the progress bar 332c is 50% (e.g., if an error is ±5%), 50% (e.g., an error is ±5%) of the image file 333a which is pre-scanned so as to correspond to the progress degree of the progress bar 332c may be displayed in the preview area 333.

The image file 333a displayed in the preview area 333 may be edited by using edit tools 334a through 334h of the toolbar area 334. Among of area designate 334a, enlarge 334b, downsize 334c, rotate 334d, left and right symmetry 334e, up and down symmetry 334f, cut 334g, and multi-crop 334h, a plurality of edit tools may be displayed in the toolbar area 334. Also, a plurality of image files 333a and 333b may be displayed in the preview area 333 through a multi-selection.

In operation S205 of FIG. 2, scanning is performed.

Referring to FIG. 5, if an image file (e.g., the image file 333a) displayed in the preview area 333 is selected, an option (e.g., an image type, an image size, or a resolution) for scanning is set, and the scan button 332b of the second status area 332 is selected, the scan application 120 or the controller 110 requests the image scanting apparatus 181 through the communication interface unit 130 to scan an image put on the flatbed or the ADF of the image scanning apparatus 181 according to the set option. The image scanning apparatus 181 scans the image according to the set option and transmits a generated image file to the communication interface unit 130. The image file received from the image scanning apparatus 181 may be temporarily stored in the storage unit of the apparatus 100. An image file 343a temporarily stored in the storage unit of the apparatus 100 is displayed in a preview area 343.

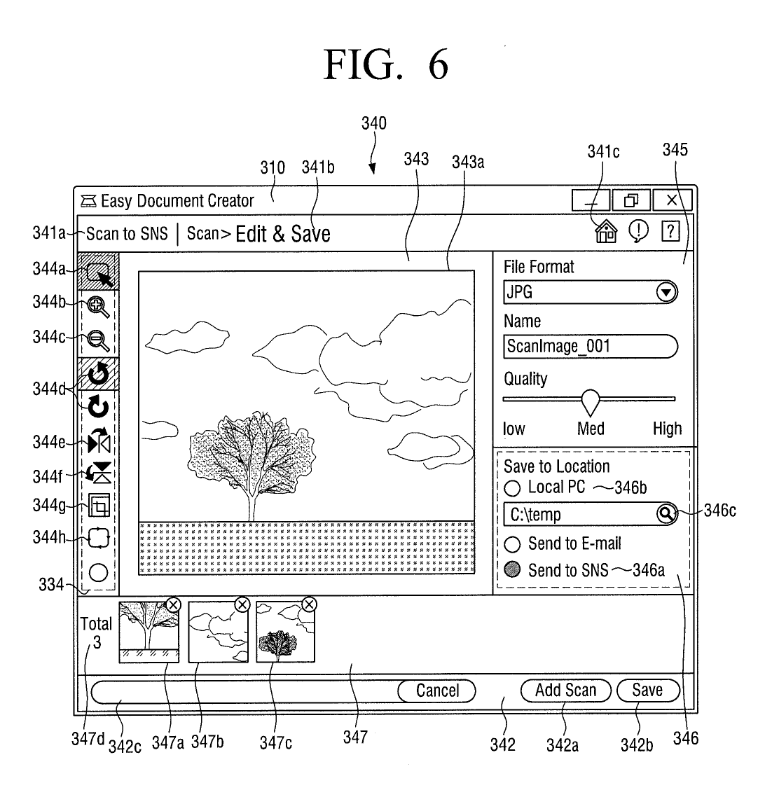

Referring to FIG. 6, a scan screen 340 includes a title area 310, a first status area 341, a second status area 342, and the preview area 343. The title area 310 displays a name of a scan application. The first status area 341 is positioned underneath the title area 310 and displays a task name 341a, a step indicator 341b, and a home button 341c for moving the scan screen 340 to the home screen 300. The second status area 342 is positioned under the first status area 341 and includes a save button 342b for saving the displayed image file 343a, an add scan button 342a for performing scanning through the image scanning apparatus 181, and a progress bar 342c for indicating a scan progress status. The preview area 343 is positioned underneath the first status area 341 and displays an image file scanned by the image scanning apparatus 181.

The scan screen 340 may include at least one of a toolbar area 344, an option area 345, and a save location area 346. The toolbar area 344 is positioned on a side of the preview area 333 and displays edit tools which are to edit the scanned image file. The option area 345 is positioned on a side of the preview area 333 and sets save options for the image file. The save location area 346 sets a save location of the image file. For example, the scan screen 340 may include combinations of the toolbar area 344, the option area 345, and the save location area 346 according to functions supported by the scan screen 340.

The scan screen 340 may include a thumbnail image area 347 which is positioned between the preview area 343 and the second status area 342 and displays thumbnail images 347a through 347c corresponding to the scanned image file and a counter 347d indicating the number of image files in a task that is in progress. The thumbnail image 347a corresponding to the image file 343a that is lastly scanned in the task in progress may be displayed to be distinguished from the thumbnail images 347b and 347c of the thumbnail area 347. The number of thumbnail images displayed in the thumbnail area 347 may be changed according to the configuration of the configuration task 316.

If the scan button 332b is selected, scanning starts in the image scanning apparatus 181, and the scan screen 340 of FIG. 6 is displayed. An image file which is generated through scanning in the image scanning apparatus 181 is transmitted to the apparatus 100. A scan progress status of the image file 343a displayed in the preview area 343 may be displayed through the progress bar 342c of the second status area 342. The scan progress status may include a scanning process of the image scanning apparatus 181, a process of transmitting a generated image file to the apparatus 100, and a process of processing the received image file in the apparatus 100. The scanning process, the transmitting process, and the image processing process may be displayed to be distinguished from one another.

The image file 343a may be displayed in the preview area 343 so as to correspond to a progress degree of the progress bar 342c. For example, if the progress degree of the progress bar 332c is 100%, the image file 343a which has been completely scanned by the image scanning apparatus 181 may be displayed in the preview area 343.

Referring to FIG. 6, “Scan>Edit & Save” indicating a process of displaying and editing a scanned image file in the preview area 343 is displayed in the step indicator 341b. If the image scanning apparatus 181 is performing scanning, “>” in the step indicator 341b blinks. If scanning is ended, blinking of “>” in the step indicator 331b is ended. According to an exemplary embodiment, blinking may be one of various display effects, and the various display effects may be changed.

The image file 343a displayed in the preview area 343 may be edited by using the edit tools 344a through 344h of the toolbar area 344. Among an area designate menu 344a, an enlarge menu 344b, a downsize menu 344c, a rotate menu 344d, a left and right symmetry menu 344e, a up and down symmetry menu 344f, cut 344g, and a crop menu 344h, a plurality of edit tools may be displayed in the toolbar area 344.

In operation S206 of FIG. 2, an image file is selected.

Referring to FIG. 6, at least one of a plurality of thumbnail images 347a through 347c displayed in the thumbnail area 347 may be selected. The image file 343a which is lastly scanned may be selected in the preview area 343. If thumbnail images different from the selected image file 343a are required to be selected, the thumbnail images 347b and 347c may be selected in the thumbnail area 347 by using the input unit 150 or a touch.

If the plurality of thumbnail images 347a through 347c are selected, other save options (e.g., a file format and a save quality) except for a file name may be similarly set in the option area 345. According to an exemplary embodiment, selected one image file 343a are exemplarily described.

In operation S207 of FIG. 2, “Send to SNS” is selected.

Referring to FIG. 6, save options corresponding to the selected image file 343a are set, and “Send to SNS” 346a is selected in the save location area 346. The save location area 346 may include “local PC” 346b which is one of options of a save location of the selected image file 343a and “save location” 346c. The selected image file 343a may be stored in the storage unit of the apparatus 100 and the storage unit of the external device. The selected image file 343a is stored as “scanimage_{—}001” in the save location 346c “c: \temp\.” The save location 346c may be changed to another save location of the storage unit.

In operation S208 of FIG. 2, an SNS site is selected.

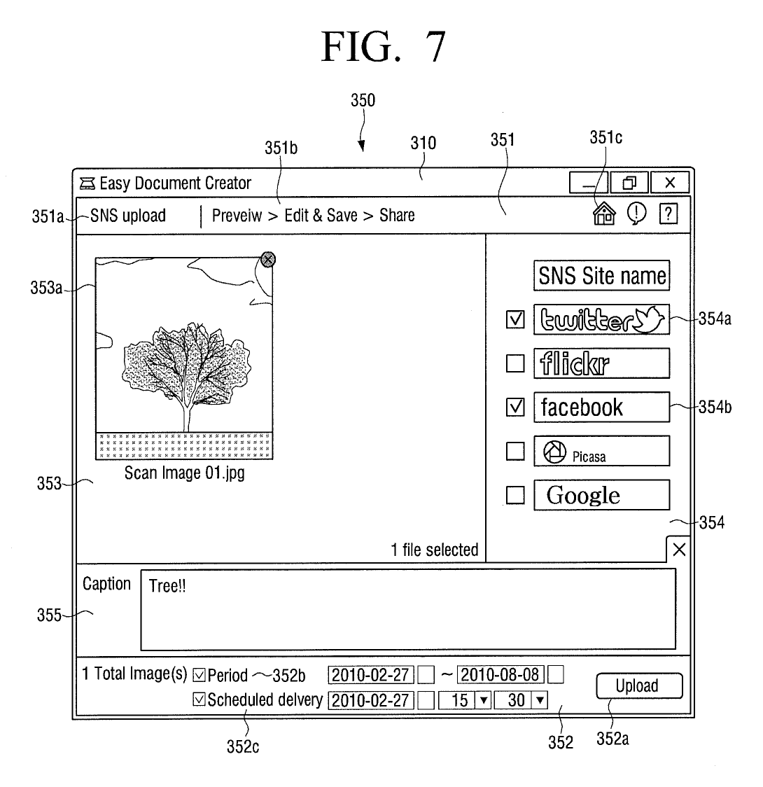

Referring to FIG. 7, an upload screen 350 includes a title area 310, a first status area 351, a second status area 352, and a preview area 353. The title area 310 displays a name of a scan application. The first status area 351 is positioned underneath the title area 310 and displays a task name 351a, a step indicator 351b, and a home button 351c for moving the upload screen 350 to the home screen 300. The second status area 352 is positioned under the first status area 351 and includes an upload button 352a for uploading a selected image file 353a, a period 352b of an uploaded image file, and a scheduled delivery 352c for uploading the selected image file 353a to a selected SNS site at scheduled date and time. The preview area 353 is positioned between the first and second status areas 351 and 352 and displays an image file which is uploaded to an SNS site. The upload screen 350 may include an SNS site list area 354 which is positioned on a side of the preview area 353 and displays a list of SNS sites to which an image file is uploaded. The upload screen 350 may selectively include a caption area 355 for inputting a caption of the uploaded image file.

Referring to FIG. 7, “Scan>Edit & Save>Share” indicating uploading of a selected image file to an SNS site is displayed in the step indicator 351b.

An SNS site (e.g., one SNS site or a plurality of SNS sites) to which the image file 353a displayed in the preview area 353 is uploaded is selected in the SNS site list area 354. If the upload button 352a of the second status area 352 is selected, the image file 353a displayed in the preview area 353 starts to be uploaded to the selected SNS site.

If a schedule (e.g., 2010-02-27 16:30) is set with respect to the selected image file 353a, and the upload button 352a is selected, the SNS service module 128e of the history manager 128 may upload the selected image file 353a to the selected SNS site at scheduled date and time by using a timer (not shown) of the apparatus 100. If a period (e.g., from 2010-02-27 to 2010-08-08) is set, the SNS service module 128e of the history manager 128 may delete the image file 353a of which period is expired in the uploaded SNS site, by using the timer of the apparatus 100 and a deletion API.

If a plurality of SNS sites 354a and 354b are selected in the SNS site list area 354, the image file 353a may be uploaded to each of the plurality of SNS sites 354a and 345b. The plurality of SNS sites 354a and 354b are exemplarily described according to an exemplary embodiment.

Referring to FIG. 7, only an SNS site, which supports the image file 353a displayed in the preview area 353, may be displayed in the SNS site list area 354. For example, an SNS site, which supports a file format (e.g., “tiff”) or a file size (e.g., 3 MB) of the image file 353a, may be displayed to be distinguished from an SNS site which does not support the file format or the file size of the image file 353a. The image file 353a may not be uploaded to the SNS site which does not support the file format or the file size, and thus the file format or the file size of the image file 353a is to be changed.

In operation S209 of FIG. 2, an SNS site is logged in.

The scan application 120 or the controller 110 logs in the SNS sites 354a and 354b selected in the SNS site list area 354, by using an SNS login setup 393 set in the configuration task 316. An ID and a password, which are to log in the selected SNS sites 354a and 354b through the stored SNS login setup 393, are set. The scan application 120 or the controller 110 logs in a selected SNS site by using an ID and a password which are preset. The preset ID and password may be stored in the storage unit (e.g., automatic login) or may be directly input by a user (e.g., manual login). Referring to FIG. 7, if the SNS site is logged in, “Scan >Edit & Save >Share” displayed in the step indicator 351 b of the first status area 351 is displayed. If the SNS site is not logged in, the method goes to operation S213.

In operation S210 of FIG. 2, an image file is uploaded to the SNS site.

If the selected SNS site is logged in (e.g., in operation S209), the selected image file 353a is uploaded sequentially to the selected SNS sites 354a and 354b by using an API corresponding to the selected SNS sites 354a and 354b.

If the SNS site is Twitter®® (hereinafter referred to as Twitter®) which does not support uploading of an image file, the image file 353a is uploaded to Twitpic® (hereinafter referred to as Twitpic), and a notification message is transmitted to the Twitter®.

An API (e.g., Upload API) for uploading an image file is disclosed in “http://twitpic.com/api.do.” The SNS upload module 124 transmits a Hypertext Transfer Protocol (HTTP) request to, for example, Internet <URL “http://twitpic.com/api/uploadAndPost/”> and receives a response from the Twitpic. After the SNS upload module 124 receives the response, the SNS upload module 124 may upload the selected image file 353a by using “<METHOD:http://twitpic.com/api/uploadAndPost>”. Therefore, the image file 353a is uploaded to the Twitpic, and the notification message is transmitted from the Twitpic to the Twitter®. Link information (e.g., <http://twitpic.com/5vnxy5>) and a caption (e.g., a tree!) corresponding to the image file 353a uploaded to the Twitpic are displayed on a time line of the Twitter®.

If the file format of the image file 353a is “jpg,” and the file size of the image file 353a is smaller than 4 Mb, the image file 353a may be uploaded to the Twitpic. If the image file 353a fails to be uploaded to the Twitpic, a pop-up (not shown) may be displayed on the upload screen 350 of FIG. 7.

If a selected SNS site is an SNS site (e.g., Facebook®®, hereinafter referred to as Facebook®) which supports uploading of an image file, it will be easily understood by those of ordinary skill in the art that the image file may be uploaded to the selected Facebook® by using Facebook® C# SDK (<http://Facebook®sdk.codeplex.com/>) and Graph API (<http://developers.Facebook®.com/docs/reference/api/>).

In operation S211 of FIG. 2, history information is stored.

History information corresponding to the image file 353a (e.g., an image file which is generated by an image scanning apparatus and uploaded or an image file which is pre-stored in the storage unit) uploaded to the SNS site is stored in the storage unit of the apparatus 100. The history information includes the plural number among a save date, a save location (e.g., c:\temp\), a file name, a file format, a size of an image file (e.g., 240 KB), and a name of an uploaded SNS site (e.g., Twitter®, Facebook®, or the like). The history information may be stored in a markup language or as a text file. The stored history information may be loaded from the history manager 128. An image file displayed in the history information may be selected to be uploaded to an SNS site by using the history information loaded from the history manger 128.

If an upload result of the image file 353a is received from the SNS site, the history save module 126 may store the history information in a name of the SNS site corresponding to the upload result.

In operation S212 of FIG. 2, the SNS site is displayed.

If the image file 353a is successfully uploaded to the selected SNS site, the scan application 120 executes a web browser 360 (e.g., corresponding to the number of SNS sites to which the image file 353a is uploaded) installed in the apparatus 100 to display the image file 353a on the display unit 155.

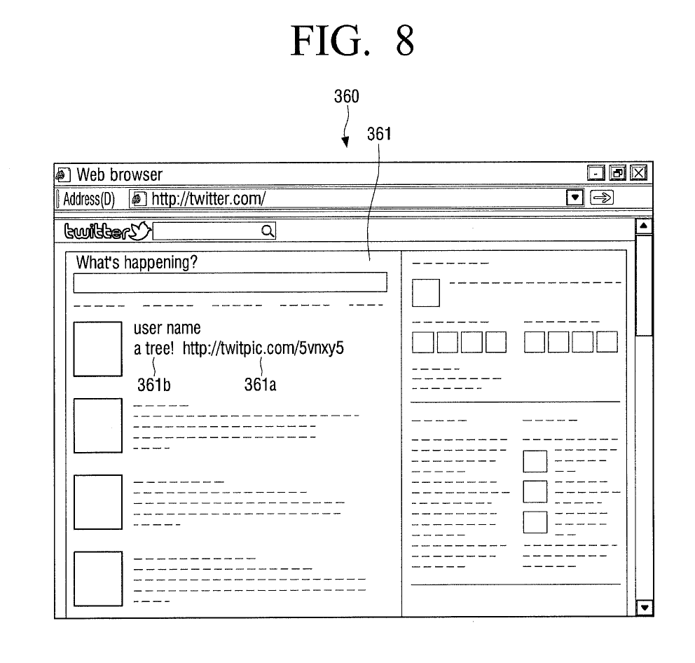

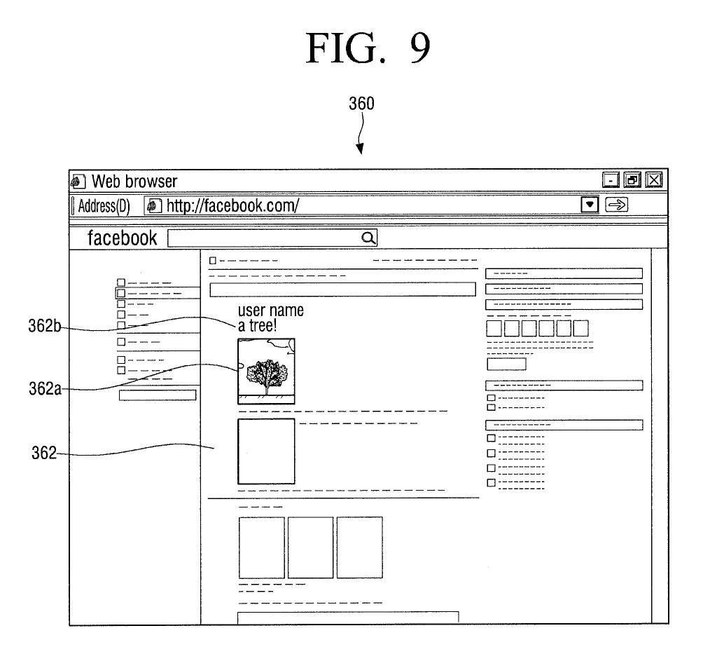

The time line of the SNS site and the image file 353a are displayed on web browser screens 361 and 362 of the web browser 360. Referring to FIG. 8, link information 361a and a caption 361b of the image file 353a which has been uploaded to the Twitpic® are displayed on the web browser screen 361. If the displayed link information 361a is selected, the image file 353a which has been uploaded to the Twitpic© may be displayed. Referring to FIG. 9, a thumbnail image 362a and a caption 362b corresponding to the uploaded image file 353a are displayed on the web browser screen 362.

A part of the web browser 360 may overlap the upload screen 350 of FIG. 7. The web browser 360 having transparency may be displayed on the upload screen 350. The transparency of the web browser 360 may be changed according to the configuration of the configuration task 316.

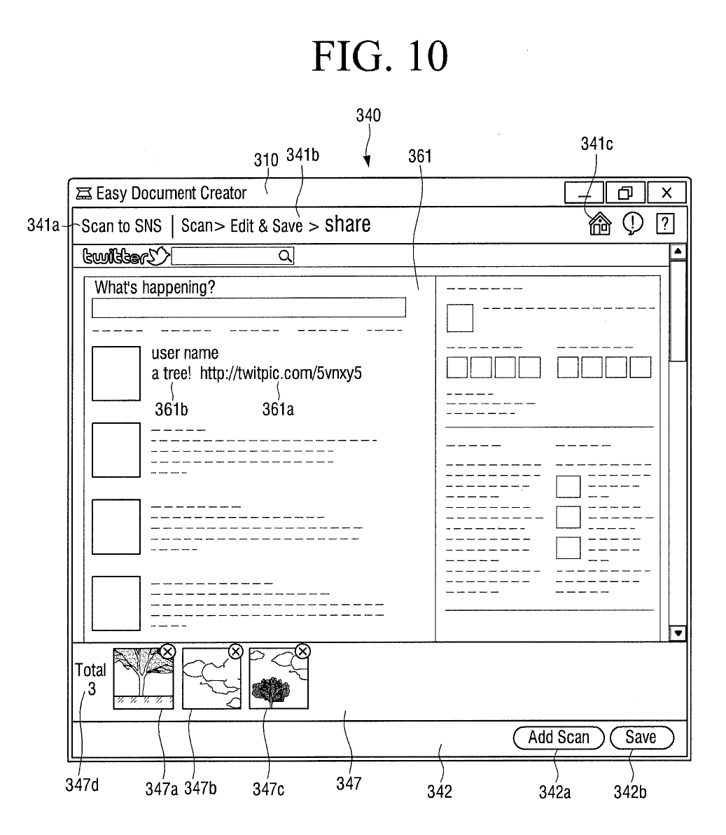

Referring to FIG. 10, if the image file 353a is successfully uploaded to the selected SNS site, the scan application 120 may display the web browser screens 361 and 362 instead of the preview area 343, the toolbar area 344, the option area 345, and the save location area 346 of the scan screen 350 of FIG. 6.

If an additional image file that is to be uploaded to the SNS site exists, the add scan button 342a may be selected to search for the additional image file. If the searched image file is displayed, an uploading process may be performed by using the upload button 342b.

History information may be stored in operation S211, and an SNS site may be displayed in operation S212.

If the SNS site to which the image file 353a has been uploaded is displayed on the web browser screens 361 and 362 of the web browser 360, an SNS uploading method of an image file in an SNS upload task to an SNS site is ended.

Referring to FIG. 4, if the SNS scan is not selected in operation S203 of FIG. 2, the SNS upload 324b of the stored the image file is selected in the SNS task type display area 324. If the SNS upload 324b of the stored image file is selected, the method goes to operation S206.

In operation S206 of FIG. 2, an image file is selected.

An image file, which is pre-stored in the storage unit of the apparatus 100 or the storage unit of the external device, may be selected under control of the scan application 120 or the controller 110. Differently from the SNS scan 324a, operation S204 and operation S205 may be skipped. If the pre-stored image file is selected, a method of uploading the pre-stored image file to an SNS site are substantially similar to operations S207 through 212 for the SNS scan 324a, and thus repeated descriptions will be omitted.

If the SNS site is not logged in (e.g., in operation S209 of FIG. 2), the method goes to operation S213.

In operation S213 of FIG. 2, login information is input.

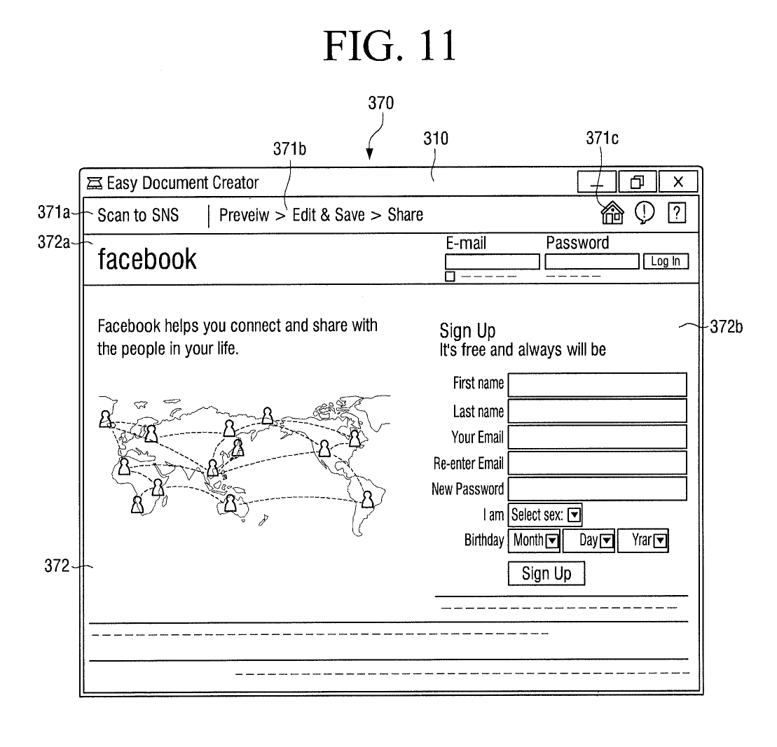

Referring to FIG. 11, an SNS login screen 370 includes a title area 310, a first status area 371, and a login display area 372. The title area 310 displays a name of a scan application. The first status area 371 is positioned underneath the title area 310 and displays a task name 371a, a step indicator 371b, and a home button 371c for moving the SNS login screen 370 to the home screen 300. The login display area 372 may be positioned underneath the first status area 371 and displays a login screen of a selected SNS site. The login display area 372 may include a subscriber area 372a and a new subscriber area 372b. A subscriber of the selected SNS site inputs an ID and a password in the subscriber area 372a. A nonmember of the selected SNS site subscribes the selected SNS site in the new subscriber area 372.

If the subscriber of the selected SNS site does not set the ID and the password in the configuration task 316, the subscriber may input the ID and the password in the subscriber area 372a. If the subscriber logs in the selected SNS site through the input ID and password, the method goes to operation S210. The nonmember of the selected SNS site may newly subscribe to the selected SNS site or may end the SNS site uploading method.

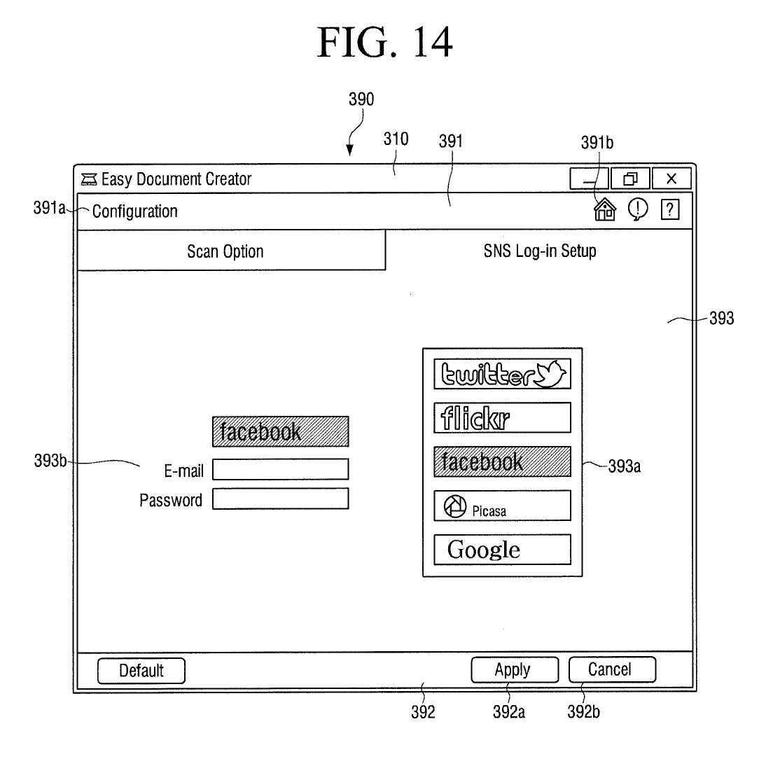

FIG. 14 exemplarily illustrates an indication of Facebook®, but it will be easily understood by those of ordinary skill in the art that the indication of Facebook® of FIG. 14 may be applied to another SNS site.

In operation S213 of FIG. 2, rather than a SNS login screen 370 for logging in, the SNS site but a pop-up (not shown) may be displayed. The pop-up may overlap the upload screen 350 of FIG. 7. The overlapping pop-up may be displayed to be activated so as to be distinguished from the upload screen 350, which is inactivated.

If the SNS upload task is not selected in operation S202 of FIG. 2, the method goes to operation S214.

In operation S214 of FIG. 2, a scan task is selected.

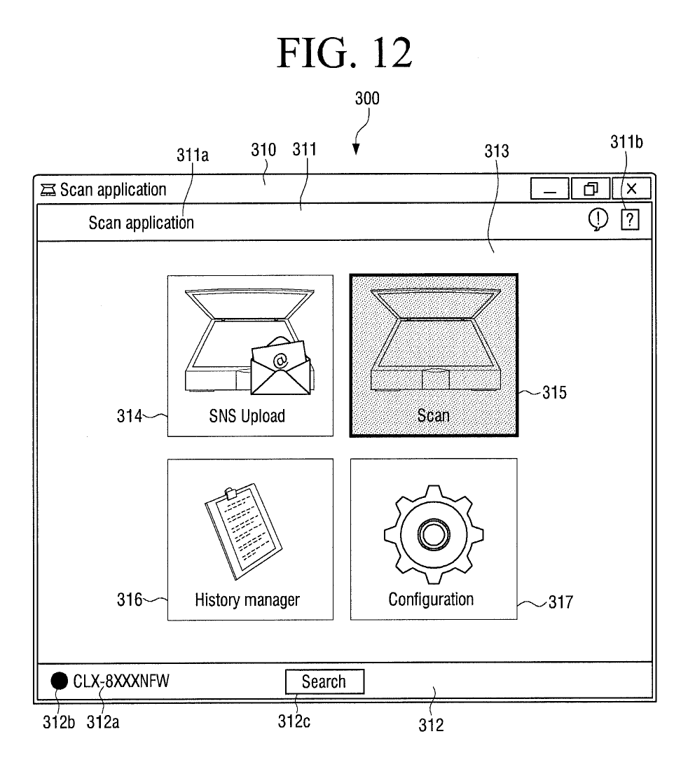

Referring to FIG. 12, as in FIG. 3, a home screen 300 is displayed, and a scan task 325 is selected in a task display area 313. Operation S214 for selecting the scan task 315 is substantially similar to operation S202, and thus repeated descriptions are omitted.

In operation S215 of FIG. 2, a scan type is selected.

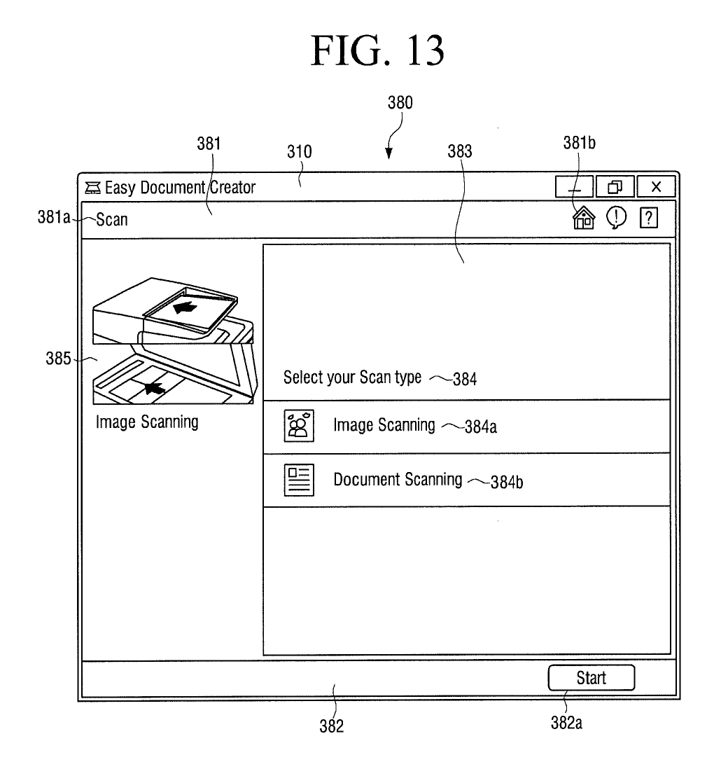

Referring to FIG. 13, a scan task screen 380 includes a title area 310, a first information area 381, a second information area 382, and a scan type display area 383. The title area 310 displays a name of a scan application. The first information area 381 may be positioned underneath the title area 310 and displays a task name 381a (e.g., a scan). The second information area 382 may be positioned under the first information area 381 and includes a start button 382a for starting tasks of selected scan types 384a and 384b. The scan type display area 383 is positioned between the first and second information areas 381 and 382 and displays a scan type 384 provided from the scan task 315. A plurality of scan types including image scanning 384a and document scanning 384b are displayed in the scan type display area 383. The image scanning 384a and the document scanning 384b displayed in the scan type display area 383 may be added or deleted according to the configuration of the configuration task 316.

The image scanning 384a is selected in the scan type display area 383 of the scan type screen 380 through the input unit 150 or a touch. The selected image scanning 384a may be displayed to be distinguished from the document scanning 384b of the scan type display area 383. If a cursor is positioned on the image scanning 384a, an icon 385 corresponding to the image scanning 384a on which the cursor is positioned is displayed on a side of the scan type display area 383.

If the start button 382a of the second information area 382 is selected, the image scanning 384a starts. If the image scanning 384a of the scan type display area 383 is selected, the image scanning 384a may start without selecting the start button 382a.

Operations S216 for pre-scanning in the image scanning 384a, operation 217 for scanning in the image scanning 384a, and operation S218 for selecting an image file in the image scanning 384a are respectively substantially similar to operation S204 for pre-scanning in the SNS scan 324a, operation S205 for scanning in the SNS scan 324a, and operation S206 for selecting an image file in the SNS scan 324a, and thus repeated descriptions will be omitted.

In operation S219 of FIG. 2, storing of the image file is selected.

Referring to FIG. 6, at least one of the plurality of thumbnail images 347a through 347c displayed in the thumbnail area 347 may be selected. The image file 343a which has been lastly scanned may be first selected in the preview area 343. If thumbnail images different from the selected image file 343a are required to be selected, the thumbnail images 347b and 347c may be selected in the thumbnail area 347 by using the input unit 150 or a touch.

Like the SNS upload task 314, an SNS upload is possible in the scan task 315. If an image file is uploaded to an SNS site, the method goes to operation S208. From operation S207, operations for uploading an image file to an SNS site in the scan task 325 are substantially similar to operations S209 through 212 in the SNS upload task 314, and thus repeated descriptions are omitted.

In operation S220 of FIG. 2, the image file is stored.

The image file 343a may be stored in a location (e.g., c: \temp\), which is set in the save location 346b of the save location area 336, under control of the scan application 120 or the controller 110. The save location 346b may be changed to another save location of the storage unit.

In operation S221, the history information is stored.

History information corresponding to the image file 343a, which is not uploaded to an SNS site but is stored in the storage unit, is stored in the storage unit of the apparatus 100. The history information includes the plural number among a save date, a save location (e.g., c:\temp\), a file name, a file format, and a size of an image file (e.g., 240 KB). The history information may be stored in a markup language or as a text file. The stored history information may be loaded from the history manager 128. An image file (e.g., 343a) displayed in the history information may be selected by using the history information loaded from the history manager 128 to be uploaded to an SNS site.

If the history information is stored, the image file SNS uploading method in the scan task is ended.

If the scan task is not selected in operation S214, the method goes to operation S222.

In operation S222 of FIG. 2, a configuration task is selected.

Referring to FIG. 3, the configuration task 317 may be selected in the task display area 313 of the displayed home screen 300. Operation S222 for selecting the configuration task 317 is substantially similar to operation S202, and thus repeated descriptions will be omitted. If the configuration task 317 is not selected, the method is ended.

In operation S223 of FIG. 2, a configuration is set.

FIG. 14 is a view illustrating an SNS login setup of an apparatus according to an exemplary embodiment.

Referring to FIG. 14, a configuration task screen 390 includes a title area 310, a first information area 391, a second information area 392, and an SNS login setup area 393. The title area 310 displays a name of a scan application. The first information area 391 is positioned underneath the title area 310 and displays a task name 391a (e.g., configuration) and a home button 391 b for moving the configuration task screen 390 to the home screen 300. The second information area 392 is positioned under the first information area 391 and includes an apply button 392a for applying an input SNS login setup and move to the home screen 300 and a cancel button 392b for moving to the home screen 300 without applying the SNS login setup. The SNS login setup area 393 is positioned between the first and second information areas 391 and 392 and sets an ID and password 393b corresponding to at least one SNS site 393a.

In the displayed SNS login setup area 393, the SNS site 393a is selected, and the subscribed ID and password 393b corresponding to the selected SNS site 393a is input. The number of tasks displayed in the task display area 313, the number of SNS upload types displayed in the task type display area 323, or the number of thumbnail images displayed in the thumbnail image area 347 may also be changed in the configuration task 317.

If the configuration is completed, a login setup of an SNS site for the image file SNS uploading method is ended.

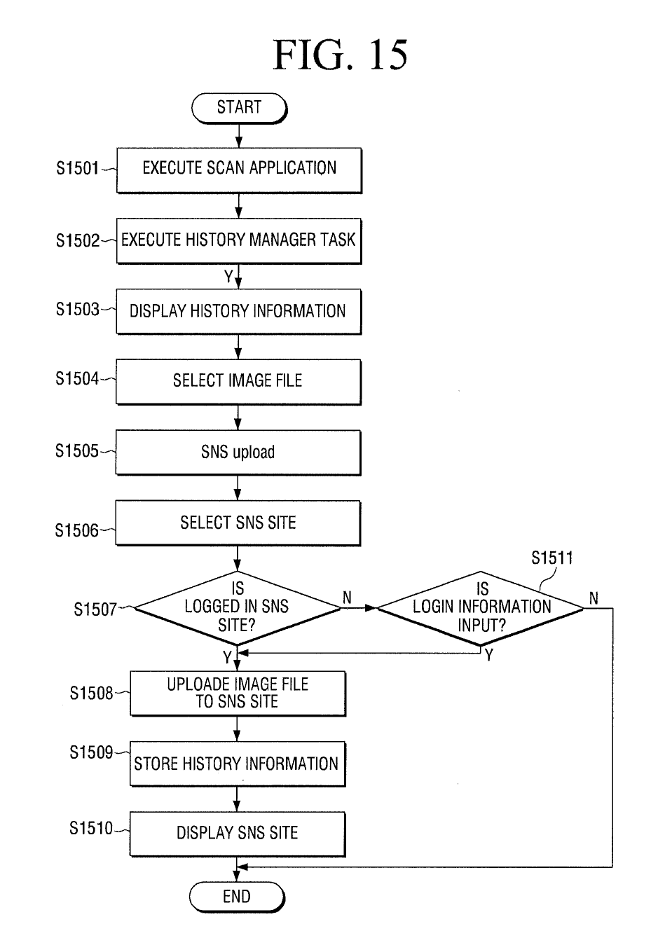

FIG. 15 is a flowchart illustrating a method of uploading an image file of an apparatus to an SNS site according to another exemplary embodiment.

In operation S1501 of FIG. 15, a scan application is executed,

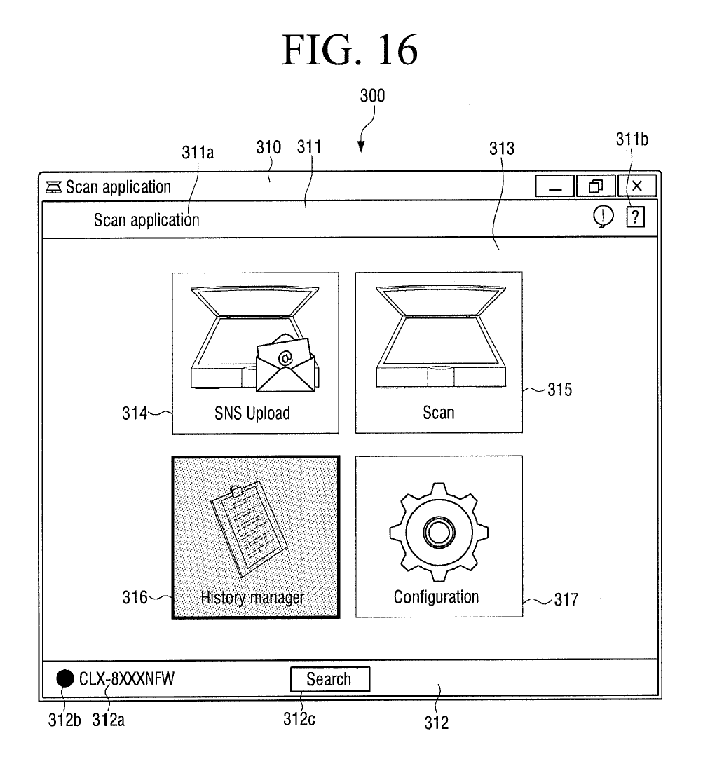

FIGS. 16 through 21 are views illustrating a method of uploading an image file of an apparatus to an SNS site according to another exemplary embodiment.

If a shortcut icon (not shown) corresponding to the scan application 120 displayed on the wallpaper of the display unit 155 is selected or a shortcut icon (not shown) corresponding to the scan application 120 displayed on the task bar is selected, the scan application 120 is executed. If the scan application 120 is executed, the home screen 300 provided by the scan application 120 is displayed.

In operation S1502 of FIG. 15, a history manager task is selected.

Referring to FIG. 16, a history manager task 316 is selected in a task display area 313 of a home screen 300. Operation S1502 for selecting the history manager task 316 is substantially similar to operation S202 for selecting the SNS upload task 314, and thus repeated descriptions are omitted.

In operation S1503 of FIG. 15, history information is displayed.

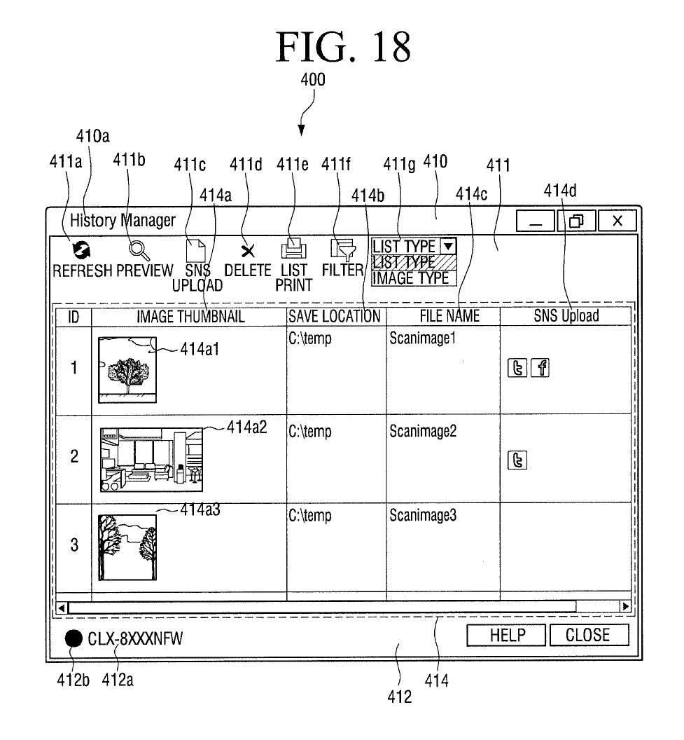

Referring to FIGS. 17 and 18, a history manager screen 400 includes a title area 410, a tool area 411, an information area 412, and a history information display area 413. The title area 410 displays a name 410a of a history manager. The tool area 411 is positioned underneath the title area 410 and displays a plurality of menus (e.g., SNS upload menus) as icons. The information area 412 is positioned under the tool area 411 and includes a model name 412a of the image scanning apparatus 181 connected to the apparatus 100 and a connection state icon 412b. The history information display area 413 is positioned between the tool area 411 and the information area 412 and displays stored history information.

The tool area 411 includes the plural number among a refresh menu 411a, preview menu 411b, an SNS upload menu 411c, a delete menu 411d, a list print menu 411e, a filter menu 411f, and a history information display type menu 411g. The refresh menu 411a is for refreshing displayed history information, and the preview menu 411b is for previewing an image file selected in the history information. The SNS upload menu 411c is for uploading the image file selected in the history information to an SNS site, and the delete menu 411d is for deleing the image file. The list print menu 411 e is for printing the history information, and the filter menu 411f is for displaying the displayed history information so that the history information corresponds to an input condition (e.g., a date). The history information display type menu 411g is for selecting the history information as an image type or a list type. The delete menu 411d of the tool area 411 may delete at least one of an image file corresponding to a thumbnail image displayed in the history information and an image file posted in an SNS site by using the SNS service module 128e. For example, the delete menu 422d may delete an image file (e.g., an image filed which has not been uploaded yet or has been uploaded) stored in the storage unit, may delete only an image file posted in an SNS site, or may delete both of the image files. If the delete menu 411d of the tool area 411 is selected, a list of image files stored in the apparatus 100 and a list of image files posted in an SNS site may be displayed. If the list of image files stored in the apparatus 100 and the list of image files posted in the SNS site does not exist, the delete menu 411d may be inactivated. At least one image file selected by a user may be deleted. The SNS service module 128e may delete an image file, which has been uploaded to an SNS site, by using the SNS login setup set in the configuration module 125 and path information of the history information stored in the history save module 126. If the image file is deleted, the history information stored in the storage unit is updated.

The history information display area 413 includes a plurality of items among a save date 413a, a save location 413b, a file name 413c, a file format 413d, a file size 413e, and a page number 413f of a stored image file and an uploaded SNS site name 413g. The file name 413c and the uploaded SNS site name 413g may be displayed as required items in the history information display area 413.

Referring to FIG. 18, a history manager screen 400 is similar to the history manager screen 400 of FIG. 17 except for a history information display area 414. The history information display area 414 of FIG. 18 includes a plurality of items including a thumbnail image 414a corresponding to stored file names 414a1 through 414a3, a save location 414b, a file name 414c, and an uploaded SNS site name 414d. The thumbnail image 414a and the uploaded SNS site name 414d may be displayed as required items in the history information display area 414. Alternatively, only the thumbnail image 414a may be displayed in the history information display area 414.

An image type or a list type may be set according to the configuration of the configuration task 317. If the history manager 128 is executed according to the set result, one of the history information of the list type of FIG. 17 and the history information of the image type of FIG. 18 is displayed. History information of a list type will be exemplarily described according to an exemplary embodiment.

In operation S1504 of FIG. 15, an image file is selected.

Referring to FIG. 18, at least one of the plurality of thumbnail images 414a1 through 414a3 displayed in the history information display area 414 may be selected by a user. The selected thumbnail image 414a1 may be displayed to be distinguished from the thumbnail images 414a2 and 414a3. The selected thumbnail image 414a1 is stored in the storage unit of the apparatus 100 without being uploaded to an SNS site. The thumbnail image 414a2 is uploaded to Twitter® and Facebook®, and the thumbnail image 414a3 is uploaded to the Twitter®. If the selected thumbnail image 414a1 is required to be previewed, the thumbnail image 414a1 may be previewed by using the preview menu 411b of the tool area 411.

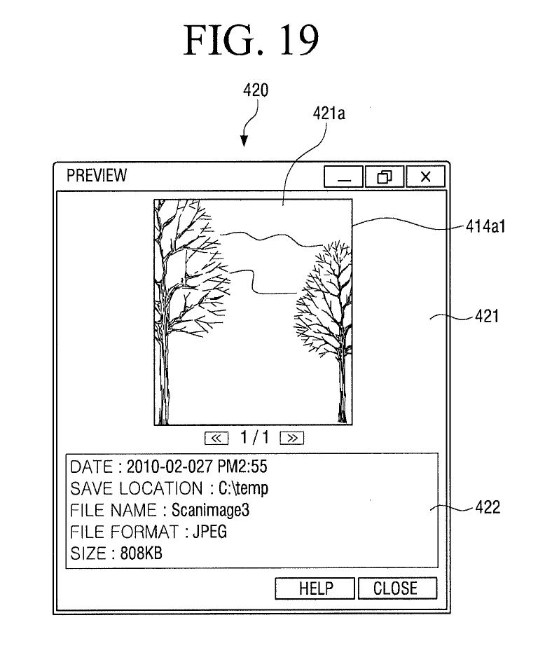

Referring to FIG. 19, a preview screen 420 includes a preview display area 421 and a detailed information display area 422. The preview display area 421 displays an image file 421a corresponding to the selected thumbnail image 414a1. The detailed information display area 422 displays detailed information (e.g., a save location, a file name, etc.) about the displayed image file 421a.

In operation S1505 of FIG. 15, an SNS upload is selected.

Referring to FIG. 18, the SNS upload menu 411c of the tool area 411 is selected through the input unit 150 or a touch to upload the selected thumbnail image 414a1 to an SNS site.

In operation S1506 of FIG. 15, an SNS site is selected.

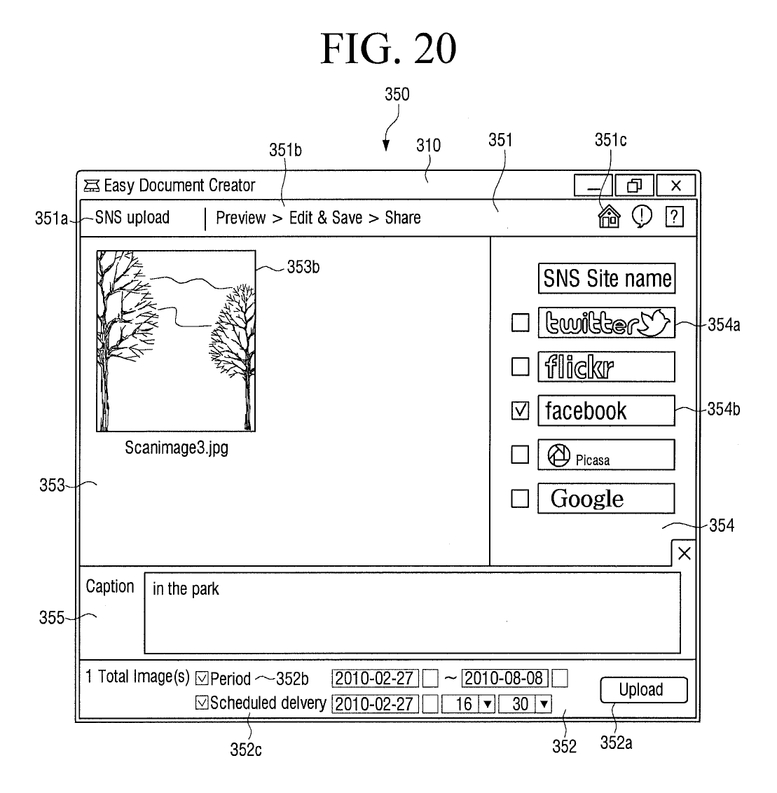

If the SNS upload menu 411c is selected in operation S1505, an upload screen 350 of FIG. 20 is displayed. An image file 353b corresponding to the selected thumbnail image 414a1 is displayed in a preview area 353 of the upload screen 350. An SNS site (e.g., Facebook®) to which the image file 353b displayed in the preview area 353 is uploaded is selected in an SNS site list area 354. A period 352b and a scheduled delivery 352c are input in a second status area 352.

The upload screen 350 of FIG. 20 is similar to the upload screen 350 of FIG. 7 except for an image file displayed in the preview area 353. Operation S1506 for selecting the SNS site is substantially similar to operation S208 of FIG. 2, and thus repeated descriptions will be omitted.

In operation S1507 of FIG. 15, the SNS site is logged in.

The scan application 120 or the controller 110 logs in an SNS site 354b selected in a SNS site list area 354 by using the SNS login setup 393 set in the configuration task 316. Operation S1507 for logging in the SNS site is substantially similar to operation S209 of FIG. 2, and thus repeated descriptions are omitted. If the SNS site is not logged in, the method goes to operation S1511.

In operation S1508 of FIG. 15, an image file is uploaded to the SNS site.

If a site selected in operation S1506 (e.g., Facebook®) is logged in, the selected image file 353b is uploaded to the SNS site 354b by using an API corresponding to the selected SNS site 353b. Operation S1508 for uploading the image file to the selected SNS site (e.g., Facebook®) is substantially similar to operation S210 of FIG. 2 for uploading the image file to Facebook®, and thus repeated descriptions are omitted.

In operation S1509 of FIG. 15, history information is stored.

History information corresponding to the uploaded image file 353b is updated in the storage unit of the apparatus 100. Referring to FIG. 18, a thumbnail image (not shown) corresponding to Facebook® may be added to the uploaded SNS site name 414d of the thumbnail image 414a3 displayed in the history information display area 414 so as to correspond to the updated history information.

In operation S1510 of FIG. 15, the SNS site is displayed.

If the image file 353b is successfully uploaded to the selected SNS site, the scan application 120 executes the web browser 360 installed in the apparatus 100 to display the image file 353b on the display unit 155.

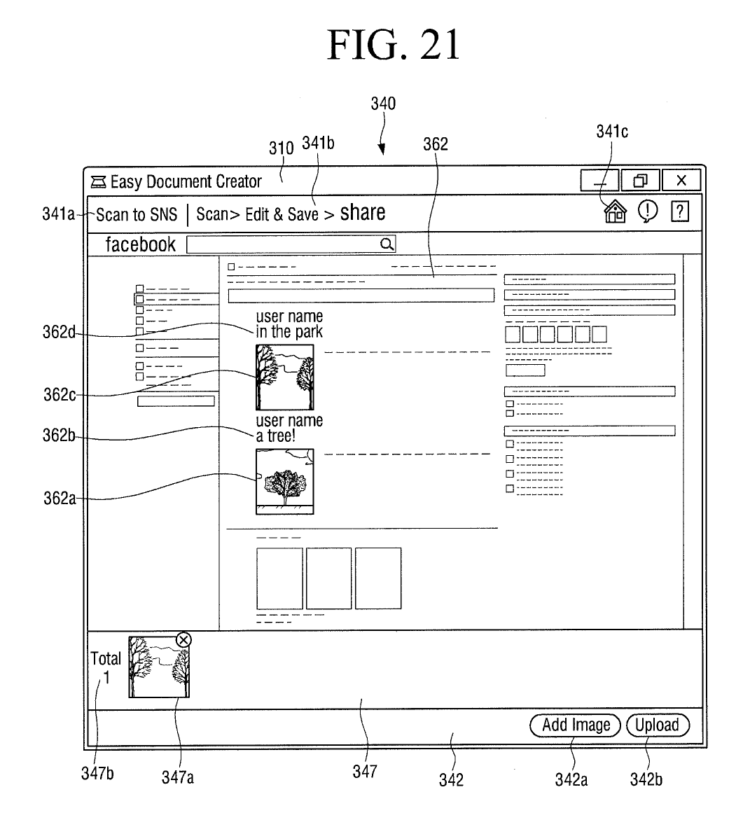

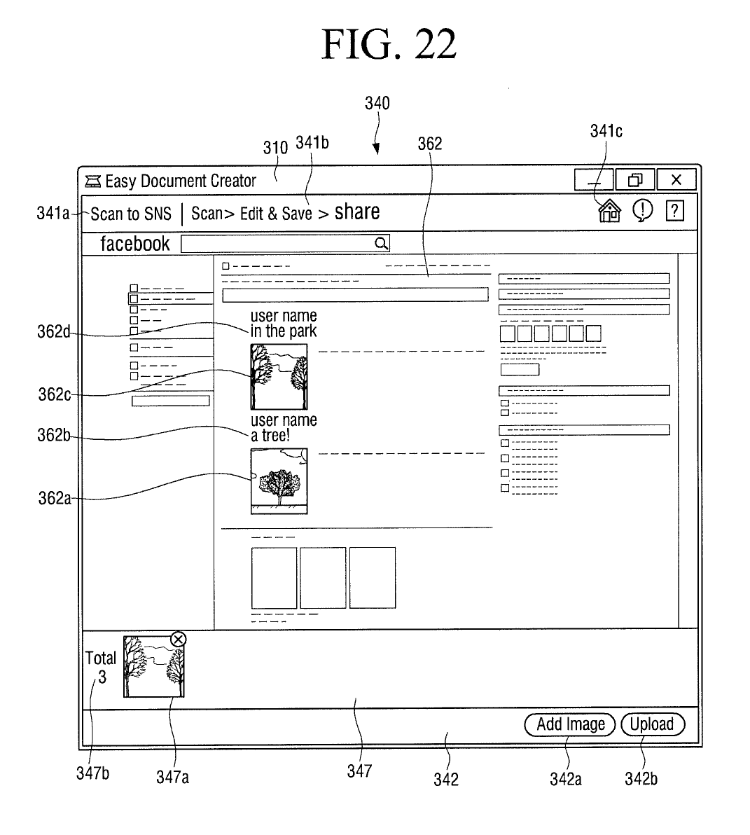

Referring to FIG. 21, a thumbnail image 362c and a caption 362d corresponding to the uploaded image file 353b are displayed in a web browser screen 362. A thumbnail image 362a and a caption 362b corresponding to the uploaded image file 353a are displayed together in the web browser screen 362. Referring to FIG. 22, if the image file 353b is successfully uploaded to the selected SNS site, the scan application 120 may display the web browser screen 362 on the upload screen 340 of FIG. 6 instead of the preview area 343, the toolbar area 344, the option area 345, and the save location area 346.

If the SNS site to which the image file 353b has been uploaded is displayed on the web browser screen 362 of the web browser 360, the image file SNS uploading method in the history manager task is ended.

If the SNS site is not logged in (e.g., in operation S1507), the method goes to operation S1511.

In operation S1511 of FIG. 15, login information is input.

Operation S1511 is substantially similar to operation S213 of FIG. 2, and thus repeated descriptions are omitted.

The methods according to the exemplary embodiments may be realized as program commands, which may be executed through various computer means, to be recorded in a computer-readable recording medium. The computer-readable recording medium may include a program command, a data file, a data structure, or combinations thereof. The program commands recorded in the computer-readable recording medium may be particularly designed or constituted for preset inventive concept or may be known to computer software manufacturers to be used.

The foregoing exemplary embodiments and advantages are merely exemplary and are not to be construed as limiting the present inventive concept. The exemplary embodiments can be readily applied to other types of apparatuses. The description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of uploading an image file of an apparatus, which is connectable to an image scanning apparatus, to a social network service (SNS) site, the method comprising:
displaying history information on a user interface (UI) screen, which is displayed on a display unit of the apparatus, through an application executed in the apparatus;
selecting an image file displayed in the history information;
selecting an SNS site; and
uploading the selected image file to the selected SNS site,
wherein the history information is generated by the application so as to correspond to one of first, second, and third image files, wherein the first image file is generated through the image scanning apparatus and uploaded to the SNS site, the second image file is generated through the image scanning apparatus and is not uploaded to the SNS site, and the third image file is stored in a storage unit of the apparatus and uploaded to the SNS site.

2. The method as claimed in claim 1, further comprising:
logging in the SNS site; and
displaying the SNS site, to which the selected image file has been uploaded, on a web browser screen executed in the apparatus.

3. The method as claimed in claim 1, wherein the history information is provided as one of an image type and a list type through the application executed in the apparatus, wherein the image type is to display a thumbnail image corresponding to an image file on the UI screen displayed on the display unit of the apparatus by the application, and the list type is to display the thumbnail image as texts corresponding to the image file.

4. The method as claimed in claim 1, wherein the SNS site is selected to be distinguishably displayed according to whether it is possible to upload the selected image file.

5. The method as claimed in claim 1, wherein the selected image file is uploaded to the selected SNS site by using an application programming interface (API) corresponding to the selected SNS site.

6. The method as claimed in claim 1, wherein the selected image file is scheduled to be uploaded to the SNS site.

7. The method as claimed in claim 1, wherein a period for which the selected image file is posted in the SNS site is set according to a post period included in the history information.

8. An apparatus which is connectable to an image scanning apparatus, the apparatus comprising:
a communication interface unit which is connectable to the image scanning apparatus;
a controller which controls the communication interface unit; and
a storage unit,
wherein the controller controls an application to display history information on a UI screen provided by the application displayed on a display unit of the apparatus, select an image file from the displayed history information, and select a Social Network Site (SNS) site to upload the selected image file to the selected SNS site, wherein the history information is generated by the application.

9. The apparatus as claimed in claim 8, wherein the history information is generated so as to correspond to a first, second, or third image file, wherein the first image file is generated through the image scanning apparatus and uploaded to the SNS site, the second image file is generated through the image scanning apparatus and is not uploaded to the SNS site, and the third image file is pre-stored in the storage unit of the apparatus and uploaded to the SNS site.

10. The apparatus as claimed in claim 8, wherein the controller controls the communication interface unit to transmit the selected image file to the SNS site by using an API corresponding to the SNS site.

11. The apparatus as claimed in claim 8, wherein the controller controls to log in the SNS site and display the SNS site, to which the image file has been uploaded, on a screen of a web browser displayed on the display unit through the login.

12. The apparatus as claimed in claim 8, wherein the apparatus and the display unit are all in one.

13. A method for uploading a file to an apparatus comprising:
displaying history information on a screen;
selecting a displayed file;
selecting a site; and
uploading the selected file to the selected site, wherein the history information is generated by an application to correspond to a file that is either generated through the apparatus and uploaded to the site, generated through the apparatus and not uploaded to the site, or stored in the apparatus and uploaded to the site.
